(19) United States
(12) Patent Application Publication
(10) Pub. No.: US 2023/0207886 A1
(43) Pub. Date: Jun. 29, 2023

(54) ALL-SOLID-STATE BATTERY WITH IMPROVED DURABILITY

(71) Applicants: HYUNDAI MOTOR COMPANY, Seoul (KR); Kia Corporation, Seoul (KR)

(72) Inventors: Sang Wan KIM, Anyang-si (KR); Young Jin NAM, Suwon-si (KR); Seon Hwa KIM, Cheongju-si (KR); Hee Soo KANG, Seoul (KR); Jae Min LIM, Suwon-si (KR); Hong Suk CHOI, Hwaseong-si (KR)

(73) Assignees: HYUNDAI MOTOR COMPANY, Seoul (KR); Kia Corporation, Seoul (KR)

(21) Appl. No.: 18/078,481

(22) Filed: Dec. 9, 2022

(30) Foreign Application Priority Data
Dec. 24, 2021 (KR) 10-2021-0186908

(51) Int. Cl. H01M 10/0585; H01M 4/133; H01M 4/134; H01M 4/36; H01M 4/587; H01M 4/38

(52) U.S. Cl. CPC H01M 10/0585; H01M 4/38; H01M 4/133; H01M 4/134; H01M 4/364; H01M 4/587; H01M 2004/027

(57) ABSTRACT

An all-solid-state battery with improved durability by preventing deposition due to non-uniform growth of lithium (Li), according to an embodiment, includes an anode layer, a solid electrolyte layer disposed on the anode layer, a cathode layer disposed on the solid electrolyte layer, and an edge part disposed at an upper surface of the anode layer to contact a side surface of the solid electrolyte layer, thereby suppressing non-uniform lithium that may be non-uniformly deposited in a conventional all-solid-state battery, in particular, non-uniform lithium that may be deposited of in a corner direction between the electrode and a solid electrolyte layer. The edge part has a lower lithium ionic conductivity than that of the solid electrolyte layer.

### CROSS REFERENCE TO RELATED APPLICATION

The present application claims priority to Korean Patent Application No. 10-2021-0186908, filed Dec. 24, 2021, the entire contents of which is incorporated herein for all purposes by this reference.

### BACKGROUND

### 1. Field of the Disclosure

The present disclosure relates to an all-solid-state battery with improved durability by preventing deposition attributable to a non-uniform growth of lithium (Li).

### 2. Description of the Related Art

An all-solid-state battery comprises a cathode composite layer bonded to a cathode current collector, an anode composite layer bonded to an anode current collector, and a solid electrolyte is disposed between the cathode composite layer and the anode composite layer.

In general, an anode layer of the all-solid-state battery is used in a composite form of an active material (graphite) and a solid electrolyte to ensure ionic conductivity in the anode layer. However, as a result, a solid electrolyte with a large specific gravity compared to a lithium-ion battery (LIB) electrolyte reduces an amount of active material in an anode, and consequently, the energy density of the all-solid-state battery is lower than that of LIB.

Research on applying metallic lithium is recently being conducted to overcome the above problems and improve the energy density of solid state batteries. However, there are many obstacles to overcome for commercialization, ranging from research technology problems such as interfacial bonding and dendrite growth to industrial technology problems such as price and large area.

Recently, research has been conducted on an anode-less type battery of a storage type battery in which an anode is omitted, and Li is directly deposited on an anode current collector side, but the storage type battery has a problem in that an irreversible reaction due to non-uniform deposition of Li is gradually increased and thus exhibits poor durability characteristics.

### SUMMARY OF THE DISCLOSURE

The purpose of solving the above problem is as follows.

An objective of the present disclosure is to provide an all-solid-state battery, including a cathode, an anode, and a solid electrolyte layer positioned between the cathode and the anode. The all-solid-state battery includes an edge part disposed at the upper part of an anode, contacting the side part of the solid electrolyte layer, and the upper part of the anode does not contact the solid electrolyte layer.

The all-solid-state battery, according to an embodiment of the present disclosure, includes: an anode layer; a solid electrolyte layer disposed on the anode layer and including a solid electrolyte; and a cathode layer disposed on the solid electrolyte layer, and may include an edge part disposed on a side surface of the solid electrolyte layer and having a low lithium ionic conductivity compared to that of the solid electrolyte layer.

The anode layer may include: an anode current collector layer; and a composite layer disposed on the anode current collector and including a carbon material and a metal capable of forming an alloy with lithium.

The metal may include at least one selected from the group consisting of gold (Au), platinum (Pt), palladium (Pd), silicon (Si), silver (Ag), aluminum (Al), bismuth (Bi), tin (Sn), zinc (Zn), magnesium (Mg), and any combination thereof.

An area of one surface of the solid electrolyte layer may be smaller than an area of one surface of the anode layer, and the edge part may be positioned in a space divided by a side surface of the solid electrolyte layer and the one surface of the anode layer.

The lithium ionic conductivity of the edge part may be 0.5% to 30% of the lithium ionic conductivity of the solid electrolyte layer.

The edge part may include at least one selected from the group consisting of polyethylene terephthalate, polyethylene, polytetrafluoroethylene, and any combination thereof.

An area of one surface of the cathode layer may be larger than an area of one surface of the solid electrolyte layer, and the border part of the cathode layer may be in contact with the edge part.

The border part area of the cathode layer may be less than or equal to 10% of a total area of the one surface of the cathode layer.

The thickness of the composite layer may be 30 µm or less.

The thickness of the solid electrolyte layer may be 50 µm or less.

The all-solid-state battery may have a current density of 6.5 mAh/cm² or less.

The all-solid-state battery, according to an embodiment of the present disclosure, includes an edge part disposed at the upper side of the anode layer and contacting the side of the solid electrolyte layer, thereby suppressing non-uniform lithium, which may be non-uniformly deposited in the existing all-solid-state battery, particularly non-uniform lithium that may be deposited in a corner direction between an electrode and a solid electrolyte layer.

### BRIEF DESCRIPTION OF THE DRAWINGS

FIG. 1 is a cross-sectional view of a conventional all-solid-state battery before and after charging and discharging;

FIG. 2 is a cross-sectional view of a conventional all-solid-state battery into which a conventional functional layer is inserted before and after charging and discharging;

FIG. 3 is a cross-sectional view of an all-solid-state battery according to an embodiment;

FIG. 4 is an enlarged cross-sectional view of a cathode, a solid electrolyte layer, and an edge part in an all-solid-state battery according to an embodiment;

FIG. 5 is a graph showing the cell performance analysis results of the all-solid-state batteries according to Example 1, Comparative Example 1, and Comparative Example 2; and

FIGS. 6A and 6B are cross-sectional views showing whether lithium deposition has occurred after charging and discharging the all-solid-state battery (FIG. 6A) according to Embodiment 1 and the all-solid-state battery (FIG. 6B) according to Comparative Example 1.

### DESCRIPTION OF THE PREFERRED EMBODIMENTS

The above objectives, other objectives, features, and advantages will be readily understood through the following preferred embodiments in conjunction with the accompanying drawings. However, it is not limited to the embodiments described herein and may be embodied in other forms. Rather, the embodiments introduced herein are provided to ensure that the disclosed content is thorough and complete and that technical ideas are sufficiently conveyed to those skilled in the art.

In describing each figure, similar reference numerals have been used for similar elements. In the accompanying drawings, the dimensions of the structures are enlarged than actual for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, it should be understood that the term “including” or “have” is intended to specify that features, numbers, steps, operations, components, parts, or a combination of them are described in the specification and does not preclude the presence or addition of one or more other features, numbers, steps, operations, elements, or combinations thereof. In addition, when a part such as a layer, film, region, plate, etc. is said to be “on” another part, this includes not only “directly above” the other part, but also the case where there is another part in the middle. Conversely, when a part such as a layer, film, region, plate, etc. is said to be “directly below” the other part, this includes not only the case where the other part is “directly below”, but also the case where there is another part between them.

Unless otherwise specified, all numbers, values, and/or expressions expressing quantities of ingredients, reaction conditions, polymer compositions, and formulations used herein contain all numbers, values, and/or expressions in which such numbers essentially occur in obtaining such values, among others. Since they are approximations reflecting various uncertainties in the measurement, it should be understood as being modified by the term “about” in all cases. In addition, when the numerical range is disclosed in the present disclosure, this range is continuous and includes all values from the minimum value to the maximum value, including the maximum value unless otherwise indicated. Furthermore, when this range refers to an integer, all integers, including the minimum value to the maximum value, including the maximum value are included unless otherwise pointed out.

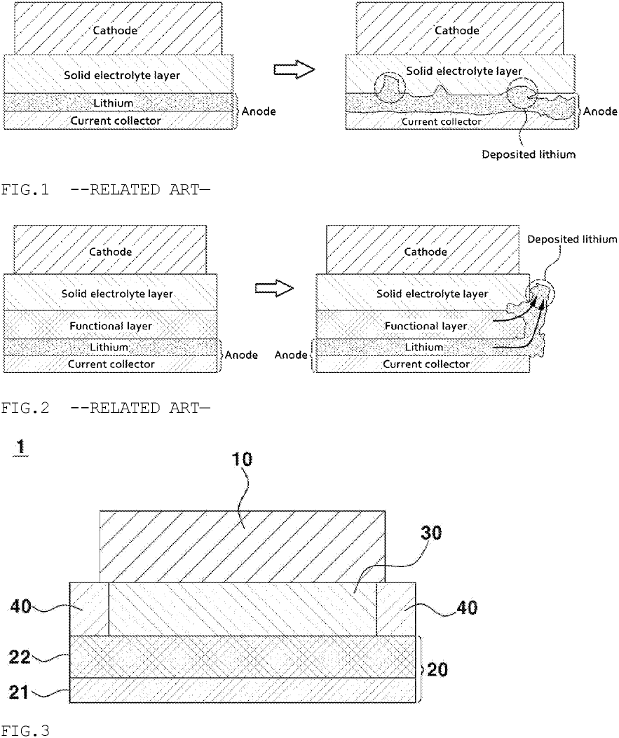

FIG. 1 is a cross-sectional view of a conventional all-solid-state battery before and after charging and discharging. Referring to FIG. 1, it can be confirmed that lithium is deposited on the anode side during charging and discharging. Accordingly, in the conventional all-solid-state battery, as charging and discharging are performed, lithium deposited may contact a solid electrolyte to cause a side reaction, thereby deteriorating the overall performance of the all-solid-state battery.

FIG. 2 is a cross-sectional view of a conventional all-solid-state battery into which a conventional functional layer is inserted before and after charging and discharging. Referring to FIG. 2, it can be confirmed that direct contact between lithium and the solid electrolyte can be prevented by the introduction of the functional layer, and the direction of deposited lithium is controlled toward the current collector due to the role of the auxiliary lithium movement of the functional layer. However, there may be a problem in that lithium is deposited and grown in the corner direction between the electrode and the solid electrolyte layer. In this case, the edge part where lithium is deposited has relatively large surface energy compared to the inside with a solid/solid interface by forming an interface between solids and gases, and in this case, when lithium is deposited, the deposited lithium grows in the corner direction to stabilize thermodynamically high surface energy. Accordingly, even when the functional layer is inserted in the conventional all-solid-state battery, the durability, and efficiency of the all-solid-state battery may be degraded or a short circuit may occur.

Accordingly, to solve the above problems, an all-solid-state battery according to one embodiment may include a cathode, an anode, and a solid electrolyte layer disposed between the cathode and the anode, and the solid electrolyte layer may be disposed at the upper part of the anode and an edge part may be further included to contact the side of the solid electrolyte layer, thereby suppressing non-uniform lithium that may be non-uniformly deposited in the existing all-solid-state battery, particularly, non-uniform lithium that may be deposited in a corner direction between an electrode and a solid electrolyte layer.

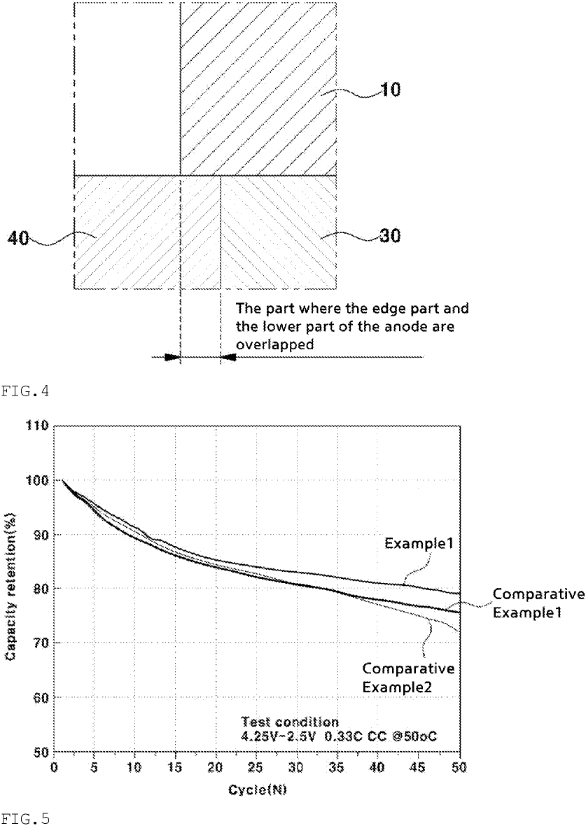

FIG. 3 is a cross-sectional view of the all-solid-state battery 1 according to an embodiment. Referring to FIG. 3, the all-solid-state battery 1 may include a cathode layer 10, an anode layer 20, and a solid electrolyte layer 30 disposed between the cathode layer 10 and the anode layer 20, and may include an edge part 40 disposed on a side surface of the solid electrolyte layer 30.

The cathode layer 10 may use a common cathode that can be used in an all-solid-state battery. Preferably, the cathode layer may include a cathode active material, a solid electrolyte, and a conductive material.

A cathode current collector layer (not shown) may be disposed on the cathode layer 10. The cathode current collector layer may be aluminum foil, SUS foil, primer-coated foil, primer-treated foil, punching foil, or the like.

The cathode active material is a typical cathode active material that can be used in an all-solid-state battery and may be an oxide active material or a sulfide active material. For example, the oxide active material may be rock salt layer-type active materials such as LiCoO₂, LiMnO₂, LiNiO₂, LiVO₂, Li₁₊ₓNi_{⅓}Co_{⅓}Mn_{⅓}O₂, etc., spinel-type active materials such as LiMn₂O₄, Li (Ni_{0.5}Mn_{1.5}) O₄, etc., inverse spinel-type active materials such as LiNiVO₄, LiCoVO₄, etc., olivine-type active materials such as LiFePO₄, LiMnPO₄, LiCoPO₄, LiNiPO₄, etc., silicon-containing active materials such as Li₂FeSiO₄ and Li₂MnSiO₄, etc., a rock salt layer-type active material partially substituted with a dissimilar metal such as LiNi_{0.8}Co_{(0.2-} ₓ₎AlₓO₂ (0<×<0.2), a spinel-type active material partially substituted with a dissimilar metal such as Li₁₊ₓMn_{2-x-y}M_{y}O₄ (M is at least one of Al, Mg, Co, Fe, Ni, Zn, 0< x+y <2), a lithium titanate such as Li₄Ti₅O₁₂. In addition, the sulfide active material may be copper Chevrel, iron sulfide, cobalt sulfide, nickel sulfide, or the like.

The solid electrolyte is a component responsible for the conduction of lithium ions, and may be an oxide-based solid electrolyte or a sulfide-based solid electrolyte. However, it is preferable to use a sulfide-based solid electrolyte having high lithium ionic conductivity.

Specifically, the solid electrolyte may be a solid electrolyte according to Formula 1 below.

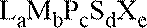

(In Formula 1, L is at least one element selected from the group consisting of alkali metals, and M is at least one element selected from the group consisting of B, Al, Ga, In, Si, Ge, Sn, Pb, As, Sb, Bi, Ti, V, Mn, Fe, Co, Ni, Cu, Y, Zr, Nb, Mo, Tc, Ru, Rh, Pd, Ag, Hf, Ta, and W, X is an element selected from the group consisting of F, Cl, Br, I and O, and 0≤a≤12, 0≤b≤6, 0≤c≤6, 0≤d≤12, and 0≤e≤9)

More preferably, the solid electrolyte may include at least one selected from the group consisting of Li₆PS₅Cl, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, Z is one among Ge, Zn, and Ga), Li₂S—GeS₂, Li₂S—SiS₂—Li₃PO₄, Li₂S—SiS₂—LiₓMO_{y} (where x and y are positive numbers, M is one among P, Si, Ge, B, Al, Ga, and In), Li₁₀GeP₂S₁₂, and the like.

In addition, a conductive material may be further included to improve electrical conductivity. Preferably, the solid electrolyte may include carbon black, conductive graphite, ethylene black, graphene, and the like.

The anode layer 20 may include an anode current collector layer 21 and a composite layer 22 positioned on the anode current collector layer 21.

The anode current collector layer 21 may be a copper foil, a nickel foil, or the like.

The composite layer 22 may include a carbon material and a metal capable of forming an alloy with lithium.

The carbon material may include at least one selected from the group consisting of carbon black and CNT.

Metals capable of forming an alloy with lithium may include at least one selected from the group consisting of gold (Au), platinum (Pt), palladium (Pd), silicon (Si), silver (Ag), aluminum (Al), bismuth (Bi), tin (Sn), zinc (Zn), magnesium (Mg), and combinations thereof.

The solid electrolyte layer 30 may include a sulfide-based solid electrolyte having high lithium ionic conductivity. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, Z is one among Ge, Zn, and Ga), Li₂S—GeS2, Li₂S—SiS₂—Li₃PO₄, Li₂S—SiS₂—LiₓMO_{y} (where x and y are positive numbers, and M is one among P, Si, Ge, B, Al, Ga, and In), Li₁₀GeP₂S₁₂, and the like.

The solid electrolyte layer 30 may have a surface of a smaller area than a surface of the anode layer 20. The edge part 40 may be positioned in a space partitioned by a side surface of the solid electrolyte layer 30 and the surface of the anode layer 20.

In particular, the edge part 40 is characterized in that the lithium ionic conductivity is lower than that of the solid electrolyte layer. Accordingly, the surface energy of the interface between the solid and gas formed at the border part is reduced to reduce the behavior of lithium growing in the border direction (outer direction), thereby suppressing the non-uniform deposition of lithium. In particular, non-uniform lithium that may be deposited in a border direction between the anode layer 20 and the solid electrolyte layer 30 may be suppressed.

The lithium ionic conductivity of the edge part 40, according to an embodiment, may be 0.5% to 30% of the lithium ionic conductivity of the solid electrolyte layer 30. If the lithium ionic conductivity of the edge part 40 is too low (e.g., less than 0.5%), there is a disadvantage in that lithium deposition is generated at the interface between the ionic conductor and the non-conductor, and if the lithium ionic conductivity of the edge part 40 is too high (e.g., greater than 30%), there is a disadvantage in that lithium is deposited and grown to the edge part as before.

FIG. 4 is an enlarged cross-sectional view of the cathode layer 10, the solid electrolyte layer 30, and the edge part 40 in the all-solid-state battery 1, according to an embodiment. Referring to FIG. 4, the area of the cathode layer 10 may be larger than that of the solid electrolyte layer 30, and a border part of the cathode layer 10 may be in contact with the edge part 40.

The ratio of the border part area of the cathode layer 10 in contact with the edge part 40 to the total area of the cathode layer 10 may be about 0.1% to 10%. If the ratio of the border part area is less than 0.1%, there is a disadvantage in that lithium is deposited on the border side. On the contrary, if the ratio of the border part area is greater than 10%, lithium is highly likely to be deposited at the interface between the anode layer 20 and the solid electrolyte layer 30, so that the deposited lithium comes into contact with the solid electrolyte layer 30 and a side reaction occurs, resulting in the performance of the all-solid-state battery.

Although not limited thereto, the border part of the cathode layer 10 may mean a space of about 3 mm from the side end of the cathode layer 10 toward the center.

In addition, when the all-solid-state battery, according to the embodiment, is charged and discharged, the thickness of the composite layer 22, the solid electrolyte layer 30, and the like, which may affect lithium that may be deposited, may be adjusted.

Specifically, the thickness of the composite layer 22 according to an embodiment may be 30 µm or less, preferably, 5 µm to 20 µm. If the thickness of the composite layer 22 is too thin outside the above range, there is a disadvantage in that cracks are generated, and durability is unstable due to volume expansion of the composite layer 22 during charging and discharging. If the thickness of the composite layer 22 is too thick (e.g., greater than 30 µm), there is a disadvantage in that energy density is lowered.

The thickness of the solid electrolyte layer 30, according to an embodiment, may be 50 µm or less, and preferably, 30 µm to 50 µm. If the thickness of the solid electrolyte layer 30 is too thin outside the above range, there is a disadvantage in that cracks are generated and durability is unstable due to volume expansion of the composite layer 22 during charging and discharging. If the thickness of the solid electrolyte layer 30 is too thick (e.g., greater than 50 µm), there is a disadvantage in that energy density is lowered.

In addition, lithium that may be deposited may be controlled by controlling the overall amount of use that may affect the lithium deposition behavior.

Specifically, according to an embodiment, the current density of the all-solid-state battery may be 6.5 mAh/cm² or less, and preferably, 2 mAh/cm² to 6.5 mAh/cm². If the current density is too low outside the above range, there is a disadvantage in that the energy density is low, and if the current density is too high (e.g., greater than 6.5 mAh/cm²), there is a disadvantage in that the cell internal resistance increases due to the increase in the resistance of the cathode layer 10.

The all-solid-state battery, according to an embodiment, may suppress non-uniform lithium that may be non-uniformly deposited in the existing all-solid-state battery, particularly non-uniform lithium that may be deposited in the corner direction between the electrode and the solid electrolyte layer, by additionally adjusting the thickness of the composite layer 22, etc., since the edge part 40 satisfying the above characteristics is disposed on the upper part of the anode layer 20 so as to contact the side of the solid electrolyte layer 30.

The present disclosure will be described in more detail with reference to the following Examples. The following Examples are only examples to help the understanding of the present disclosure, and the scope of the present disclosure is not limited thereto.

### Example 1: Preparation of All-Solid-State Battery

A cathode layer includes NCM as a cathode active material.

In addition, an anode layer includes a composite layer including Ag on an anode current collector. The thickness of the composite layer is 10 µm.

In addition, a solid electrolyte composition was prepared by using the composition in accordance with Table 1 below as a solid electrolyte layer, and then a slurry was prepared as shown in Table 1, and as a result, a solid electrolyte layer with a thickness of 50 µm was prepared.

At this time, the solid electrolyte was Li₆PS₅Br_{0.5}Cl_{0.5}, the dispersant was LPN22980, and the solvent was hexyl butyrate.

In addition, the edge part was prepared by preparing a composition as shown in Table 1 below, and then the slurry was prepared as shown in Table 1, and as a result, the edge part having lithium ionic conductivity, as shown in Table 1, below was prepared.

### Comparative Example 1: Preparation of All-Solid-State Battery

When compared to Example 1, an all-solid-state battery was prepared in the same manner as in Example 1, except that the edge part was formed of an insulator.

### Comparative Example 2: Preparation of All-Solid-State Battery

When compared to Example 1, the all-solid-state battery was prepared in the same manner as in Example 1 except that the edge part was not included.

TABLE 1

| Division | | | Solid electrolyte layer | Example 1 (Edge part) | Comparative Example 1 (Edge part) |
|---|---|---|---|---|---|
| Composition | Solid electrolyte Composition | Solid electrolyte (%) | 95.86% | 95.86% | - |
| | | Binder (%) | 3.84% | 3.84% | - |
| | | Dispersin g agent (%) | 0.30% | 0.30% | - |
| | Solvent | Moisture content (ppm) | 20 | 500 | - |
| Slurry | Design Solids (%) | | 56.31 | 56.31 | - |
| | D50 (µm) | | 2.99 | 2.99 | - |
| | Width | | 4.7 | 4.7 | - |
| Solid electrolyte layer | Moisture (ppm) | | 0 | 9487 | - |
| | Ionic conductivity (mS/cm) | | 2.09 | 0.715 | - |

### Experimental Example 1: Analysis of Cell Performance of All-Solid-State Batteries

After all-solid-state batteries were prepared according to Example 1, Comparative Example 1, and Comparative Example 2, cell performance was analyzed, and the results are shown in FIG. 5.

Referring to FIG. 5 , it can be seen that the cell performance of the all-solid-state battery according to Comparative Example 2 is relatively deteriorated due to the occurrence of a circuit short, whereas the cell performance of the all-solid-state battery according to Example 1 is improved and enhanced.

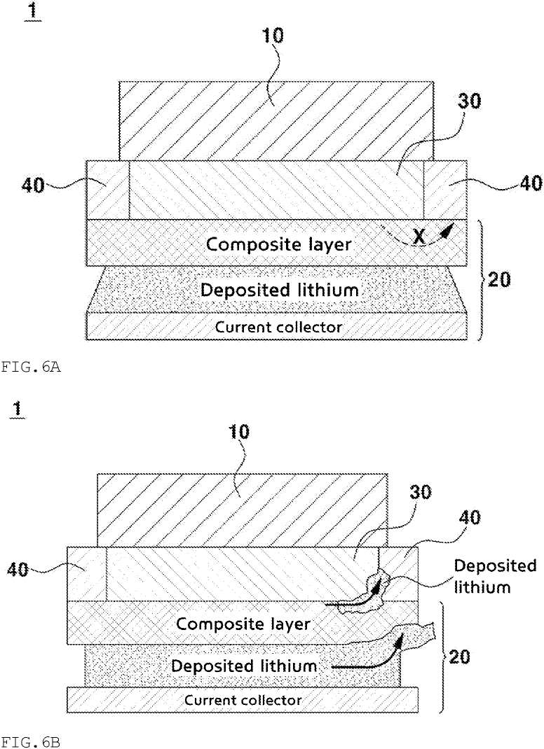

FIGS. 6A and 6B are cross-sectional views showing whether lithium deposition has occurred after charging and discharging the all-solid-state battery (FIG. 6A) according to Embodiment 1 and the all-solid-state battery (FIG. 6B) according to Comparative Example 1.

Referring to FIG. 6A, in the all-solid-state battery, according to Example 1, an edge part with an ionic conductivity approximately ⅓ lower than that of the solid electrolyte layer is disposed at the upper part of the anode layer, thereby suppressing non-uniform lithium that may be deposited in the edge direction between the electrode and the solid electrolyte layer, thereby improving cell performance.

On the other hand, referring to FIG. 6B , in the all-solid-state battery according to Comparative Example 1, even when the non-conductive edge part is disposed on the upper side of the anode, non-uniform lithium is deposited in the edge direction between the electrode and the solid electrolyte layer, thereby degrading cell performance compared to the all-solid-state battery of Example 1.

According to one embodiment, the all-solid-state battery may include an edge part disposed at an upper part of the anode layer to contact a side part of the solid electrolyte layer, and particularly, the edge part may satisfy specific characteristics such as a lithium ionic conductivity and a length of a part in contact with a lower part of the edge part. Non-uniform lithium that may be non-uniformly deposited in a conventional all-solid-state battery, particularly, non-uniform lithium that may be deposited in a corner direction between an electrode and a solid electrolyte layer may be suppressed.

What is claimed is:

1. An all-solid-state battery comprising:
an anode layer;
a solid electrolyte layer disposed on the anode layer and comprising a solid electrolyte;
a cathode layer disposed on the solid electrolyte layer; and
an edge part disposed on a side surface of the solid electrolyte layer and having a lower lithium ionic conductivity than that of the solid electrolyte layer.

2. The all-solid-state battery of claim 1, wherein the anode layer comprises:
an anode current collector layer; and
a composite layer disposed on the anode current collector layer and comprising a carbon material and a metal capable of forming an alloy with lithium.

3. The all-solid-state battery of claim 2, wherein the metal comprises at least one selected from the group consisting of gold, platinum, palladium, silicon, silver, aluminum, bismuth, tin, zinc, magnesium, and any combination thereof.

4. The all-solid-state battery of claim 1, wherein an area of one surface of the solid electrolyte layer is smaller than an area of one surface of the anode layer, and the edge part is positioned in a space defined by the side surface of the solid electrolyte layer and the one surface of the anode layer.

5. The all-solid-state battery of claim 1, wherein the lithium ionic conductivity of the edge part is 0.5% to 30% of that of the solid electrolyte layer.

6. The all-solid-state battery of claim 1, wherein the edge part comprises at least one selected from the group consisting of polyethylene terephthalate, polyethylene, polytetrafluoroethylene, and any combination thereof.

7. The all-solid-state battery of claim 1, wherein an area of one surface of the cathode layer is larger than an area of one surface of the solid electrolyte layer, and a border part of the cathode layer is in contact with the edge part.

8. The all-solid-state battery of claim 7, wherein an area of the border part of the cathode layer is 10% or less of a total area of the one surface of the cathode layer.

9. The all-solid-state battery of claim 2, wherein the composite layer has a thickness of 30 µm or less.

10. The all-solid-state battery of claim 1, wherein the solid electrolyte layer has a thickness of 50 µm or less.

11. The all-solid-state battery of claim 1, wherein a current density of the all-solid-state battery is 6.5 mAh/cm² or less.
